(19) United States
(12) Patent Application Publication
(10) Pub. No.: US 2011/0058257 A1
(43) Pub. Date: Mar. 10, 2011

(54) OPTICAL ELEMENT

(75) Inventors: PO-WEN LIN, KAOHSIUNG (TW); SHIH-JUNG CHEN, KAOHSIUNG (TW); HSUNG-HSING WANG, KAOHSIUNG (TW); PEI-HSIN CHEN, KAOHSIUNG (TW)

(73) Assignee: ETERNAL CHEMICAL CO., LTD., KAOHSIUNG (TW)

(21) Appl. No.: 12/875,936

(22) Filed: Sep. 3, 2010

(30) Foreign Application Priority Data
Sep. 4, 2009 (TW) 098130007

(51) Int. Cl. G02B 5/02; G02B 27/12

(52) U.S. Cl. 359/599; 359/625

(57) ABSTRACT

The present invention provides an optical element, which comprises:
(a) a substrate,
(b) a first surface on one side of the substrate wherein said first surface comprises a plurality of prism columnar structures with rounded peaks and the curvature radii of the rounded peaks are in the range from 3 μm to 20 μm, and
(c) a second surface on the other side of the substrate wherein the second surface can be a plane surface or with concave-convex structures.

### BACKGROUND OF THE INVENTION

1. Field of the Invention

The present invention relates to an optical element, more particularly to an optical element applied in a direct lighting backlight module.

2. Description of the Prior Art

Conventional backlight modules can be divided into edge lighting, direct lighting, and embedded lighting backlight modules according to the position of the light source. The edge lighting backlight module has a light source disposed at a side edge of the module, has features such as light weight, thin structure and low power consumption, and is particularly suitable for use in a mobile phone, a personal digital assistant (PDA), or a notebook computer. However, due to the thinness of the light guide plate, the number of light sources disposed at the side edge is limited. Therefore, the edge lighting backlight module is generally only used in small- or medium-sized products below 18 inches, and cannot provide sufficient light sources for a large-sized liquid crystal display (LCD). The direct lighting and embedded lighting backlight modules have a plurality of light sources disposed on a bottom surface of the module, so light is emitted upward through the front side. With their capability of providing sufficient light sources and advantages such as high brightness, wide viewing angle and high light utilization efficiency, the direct lighting and embedded lighting backlight modules are generally used in large-sized products such as LCD monitors and LCD televisions, in which their relatively large thickness and heavy weight matter less.

Generally, the light source of the direct lighting backlight module is a cold cathode fluorescent lamp (CCFL) or a light emitting diode (LED). The CCFL has advantages such as high brightness, high efficiency and long service life, and has a columnar configuration which is easily combined with a light reflection element to form a thin-plate illuminator, and thus has become the main light emitting element of the direct lighting backlight module. However, the CCFL in the direct lighting backlight module is disposed below the liquid crystal panel in parallel, and if the light is not properly diffused and uniformized, an obvious lamp profile will easily appear on the display screen due to non-uniform light intensity distribution, thereby deteriorating the image quality. Moreover, as high brightness is necessary, the larger the size of the direct lighting backlight module, the greater the number of lamps required, and the severer the occurrence of bright and dark stripes. This has become a problem for LCD development.

Currently, there are two main solutions to the problem. One is increasing the distance between the light source and the light guide plate or diffuser, so as to alleviate the occurrence of bright and dark stripes. However, when the distance between the light source and other elements is increased, not only does the brightness attenuate, but also the overall thickness of the backlight module is increased accordingly, and both problems go against the requirements for light weight, thin structure and high light utilization efficiency of the backlight module. Another solution is disposing a diffusing element and a prism element between the light source and the liquid crystal panel and using their light diffusing and converging functions to diffuse and uniformize the light emitted from the lamp, and then reduce the angle of divergence to converge the light in an on-axis direction of about ±35°, so as to effectively couple the light into the liquid crystal panel and achieve an uniform light output. However, such a design often leads to low brightness or cannot completely eliminate the problem of bright and dark stripes.

As shown in FIG. 1, U.S. Pat. No. 6,280,063 discloses a composite optical gain element, which includes a substrate 12, a diffusion layer 14 at the bottom of the substrate, and a microstructure layer 16 on the substrate and opposite to the diffusion layer. The optical gain element performs light diffusing and converging steps by using the diffusion layer 14 and the microstructure layer 16, so as to achieve a uniformization effect. Since the peaks of the prism columnar structures of the microstructure layer 16 are rounded, abrasion resistance can be increased; however, due to the excessively large curvature radii of the rounded peaks (about 20% to 45% of the prism width), the light converging effect is poor. Moreover, light-scattering particles 18 in the diffusion layer 14 easily scratch adjacent elements during assembly and use of the diffusion layer, thereby affecting the optical properties.

As shown in FIG. 2, US Patent Application No. 2008/0225207 discloses an optical sheet, which includes a plurality of semi-columnar light converging structures doped with diffusion beads, so as to prevent damage to the light converging structures resulting from abrasion by adjacent elements and improve the uniformization effect. However, the light converging effect of the semi-columnar structures is poor, and since light utilization is reduced due to the presence of the diffusion beads, the brightness is too low.

In view of the above, developing an optical element which can be used in a direct lighting backlight module and had such advantages as light uniformization, high light utilization efficiency and low cost has become an urgent task in the relevant field.

### SUMMARY OF THE INVENTION

The present invention provides an optical element, which comprises:

(a) a substrate;

(b) a first surface on one side of the substrate, wherein the first surface comprises a plurality of prism columnar structures with rounded peaks having curvature radii in the range from 3 μm to 20 μm; and

(c) a second surface on the other side of the substrate, wherein the second surface can be a plane surface or with concave-convex structures.

The optical element of the present invention has light uniformizing and converging effects, and can be prevented itself from being scratched or from scratching other adjacent elements.

### BRIEF DESCRIPTION OF THE DRAWINGS

FIG. 1 is a schematic view of a conventional composite optical gain element.

FIG. 2 is a schematic view of another conventional composite optical gain element.

FIG. 3 is a schematic view of an optical element according to the present invention.

FIGS. 4 to 7 are schematic views of specific embodiments of the optical element according to the present invention.

FIG. 8 is a schematic view of the assembly of a backlight module with an exemplified optical element according to the present invention.

FIG. 9 is a diagram of normalization of brightness values of a longitudinal central axis of a central region of a backlight module without any optical element.

FIG. 10 is a diagram of normalization of brightness values of a longitudinal central axis of a central region of a backlight module having the optical element of Example 1.

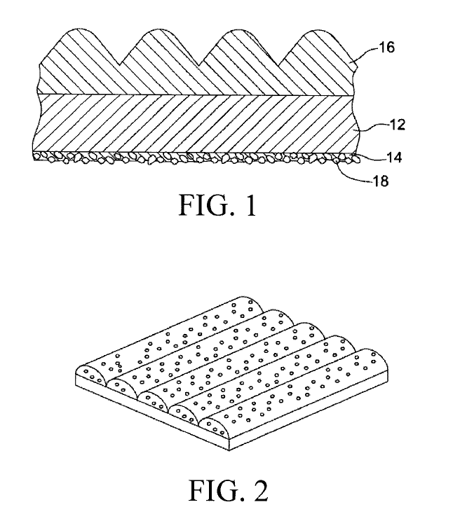

### DETAILED DESCRIPTION OF THE INVENTION

The terms used herein are merely for describing the embodiments of the present invention, but not intended to limit the scope of the present invention. For example, as used in the specification, the terms “a” and “an” encompass singular and plural references, unless otherwise explicitly stated.

As used herein, the term “prism columnar structure” represents a structure formed by two slanted surfaces, the slanted surfaces can be plane or curved surfaces, and the two slanted surfaces intersect with each other at the top of the prism columnar structure to form a peak, and may each intersect with another slanted surface of an adjacent columnar structure at the bottom to form a valley.

As used herein, the term “prism width” is defined as a maximum distance between the two valley lines of the prism columnar structure.

As used herein, the term “linear prism columnar structure” is defined as a columnar structure where the ridge of the prism columnar structure extends as a straight line.

As used herein, the term “serpentine prism columnar structure” is defined as a prism columnar structure where the ridge of the prism columnar structure extends as a curved line, the surface curvature of the curved ridge suitably varies, and the variation in the surface curvature of the curved ridge is 0.2% to 100%, preferably 1% to 20%, based on the height of the serpentine prism columnar structure.

As used herein, the term “pencil hardness” refers to the hardness obtained by measuring a surface of a sample with a Mitsubishi pencil in accordance with Standard Method JIS K-5400.

The material of the substrate according to the present invention can be any suitable materials known to a person of ordinary skill in the art, for example, glass and plastic. A plastic substrate can be composed of one or more polymeric resin layers. The types of the resins used in the polymeric resin layers are not particularly restricted and can be, for example, but not limited to, any one selected from the group consisting of polyester resins such as polyethylene terephthalate (PET) and polyethylene naphthalate (PEN), polyacrylate resins such as polymethyl methacrylate (PMMA), polyolefin resins such as polyethylene (PE) and polypropylene (PE), polycycloolefin resins, polyimide resins, polycarbonate resins, polyurethane resins, triacetyl cellulose (TAC), polylactic acids and a combination thereof. Among the above, polyester resins, polycarbonate resins and a combination thereof are preferred and PET is more preferred. The thickness of the substrate usually depends on the requirements of the optical product and is normally in the range from 15 μm to 300 μm.

The first surface of the substrate of the present invention has a microstructure layer, and the microstructure layer comprises a plurality of prism columnar structures with rounded peaks. With the prism columnar structures (for light converging effect) with the rounded peaks (for light diffusion effect), both light uniformizing and converging effects can be achieved. For the prism columnar structures having the same apex angle, the larger the prism width is, the better the light converging effect will be. However, if the prism width is too large, visible bright and dark stripes may occur, thereby affecting the image quality. The prism width commonly used in the industry is about 30 μm to about 100 μm. On the other hand, if the curvature radii of the rounded peaks are less than 2 μm, although the light converging effect is good, the peaks are easily damaged due to collision or contact with other elements. If the curvature radii of the rounded peaks are large, the scratch resistance is good, and a light diffusion property can be obtained, thereby achieving a light uniformizing effect. However, if the curvature radii are too large, the light converging effect is poor, and the brightness gain decreases. The inventors found that when the curvature radii of the rounded peaks are in the range from 3 μm to 20 μm, preferably from 5 μm to 15 μm, and more preferably from 7 μm to 12 μm, both good light converging and uniformizing effects can be obtained, which meets the current demand in the industry. Moreover, the curvature radii of the rounded peaks are preferably 5-20%, and more preferably 10-20% of the prism width.

The prism columnar structure may be a linear prism columnar structure, a serpentine prism columnar structure or a zigzag prism columnar structure, and preferably a linear prism columnar structure. The peak height of the columnar structure of the present invention may vary or not vary in the extending direction. The expression that the peak height of the columnar structure varies in the extending direction refers to that the height of at least a part of positions in the columnar structure varies randomly or regularly along a primary axis of the structure, with an amplitude of variation being at least 3%, and preferably 5% to 50% of the nominal height (or average height).

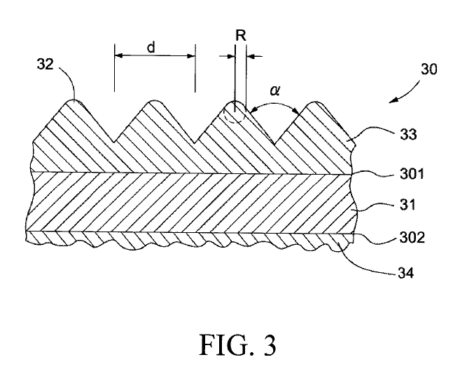

FIG. 3 is a schematic view of an embodiment of the optical element according to the present invention. As shown in FIG. 3, an optical element 30 includes a substrate 31. The substrate includes a first surface 301 and a second surface 302. The first surface 301 includes a microstructure layer 33 formed by a plurality of prism columnar structures 32 with rounded peaks. The prism columnar structures have the same height and width, and are parallel to one another. The second surface 302 has concave-convex structures 34. The prism columnar structure 32 has a width d, and is formed by two slanted surfaces, where the two slanted surfaces are bent at the top of the prism to form a rounded peak having a curvature radius R. Moreover, the two slanted surfaces each intersect with another slanted surface of an adjacent prism columnar structure at the bottom to form a valley, with a valley angle α.

According to the present invention, the valley angles (α) of the prism columnar structures may be the same or different, and are preferably about 70° to about 110°, and more preferably about 85° to about 95°. The curvature radii of the rounded peaks may be the same or different, and may be about 3 μm to about 20 μm, preferably about 5 μm to about 15 μm, and more preferably 7 μm to 12 μm. The widths of the prism columnar structures may be the same or different, and are preferably about 30 μm to about 100 μm, and more preferably about 40 μm to about 70 μm.

In order to alleviate the optical interference phenomenon, the microstructure layer of the present invention may include at least two non-parallel prism columnar structures. According to the present invention, the microstructure layer includes at least one set of two non-parallel prism columnar structures intersecting with each other and/or at least one set of two non-parallel prism columnar structures not intersecting with each other.

The microstructure layer of the present invention may be prepared by any method well known to persons of ordinary skill in the art. For example, it can be prepared integrally with the substrate by, for example, embossing or injection; or a prepared microstructure layer is laminated on the substrate; or a first resin coating is coated on the upper side of the substrate by a roll-to-roll continuous manufacturing process and cured to form the required microstructure. The thickness of the microstructure layer of the present invention is not particularly limited, and is typically in the range from about 1 μm to about 50 μm, preferably 5 μm to 35 μm, and most preferably 15 μm to 25 μm.

The microstructure layer of the present invention preferably has a glass transition temperature (Tg) less than 40° C., and more preferably has a glass transition temperature less than 35° C. In this case, the microstructure layer is resilient, that is, it can restore its original shape after the stress is released. When tested according to JIS K-5400, the microstructure layer can pass a HB Pencil Hardness Test, and thus is scratch resistant. In addition, the resilient microstructure layer is also abrasion resistant, and when an abrasion test is carried out according to ASTM D4060 (CS-10 wheel, 1,000 g, 1,000 cycles), the abrasion loss is less than 100 mg, preferably less than 50 mg, and more preferably less than 25 mg, so as to prevent the optical element from being scratched or scratching adjacent optical elements, thereby avoiding reducing the brightness or affecting the image quality. Further, with the resilient microstructure layer of the optical element, a protective film can be omitted, thereby reducing the manufacturing cost. The above-mentioned glass transition temperature can be measured by any method well known to persons of ordinary skill in the art, for example, by differential scanning calorimetry (DSC), modulated DSC, or dynamic mechanical analysis (DMA).

The second surface of the substrate of the present invention is located on the other side of the substrate opposite to the microstructure layer, and may be a surface of the original substrate film, or the surface processed by any conventional method. The processing method comprises, for example, applying a second resin coating onto the substrate, and curing the second resin coating to form a planar coating layer, such that the second surface has a planar structure; or first applying a resin coating, and then forming and curing a resin coating by embossing with a roller having concave-convex structures on surfaces thereof so as to form a coating layer having concave-convex microstructures, such that the second surface has concave-convex structures, thereby providing a light diffusion effect. The thickness of the coating layer is not particularly limited, and is typically in the range from about 0.5 μm to about 30 μm, and preferably in the range from about 1 μm to about 10 μm.

According to a preferred embodiment of the present invention, after the second resin coating is coated on the substrate, concave-convex structures are formed by embossing with a sand blasting roller, and then cured, such that the second surface has concave-convex structures without any diffusion beads.

To enhance the haze effect of the optical element so as to enable the light to be more uniform after passing through the optical element, the second resin coating may optionally contain beads to enhance the light diffusion effect, which may be, for example, but not limited to, glass beads; metal oxide beads, for example, but not limited to titania (TiO₂), silicon dioxide (SiO₂), zinc oxide (ZnO), alumina (Al₂O₃), zirconia (ZrO₂) or a mixture thereof; or plastic beads, for example, but not limited to, an acrylate resin, styrene resin, urethane resin, silicone resin or a mixture thereof, preferably an acrylate resin or silicone resin or a combination thereof. The shape of the beads is not particularly limited, and may be, for example, spherical, diamond-like, oval, rice-like or biconvex lenses-shaped, and the beads have an average particle size in the range from about 1 μm to about 10 μm. The haze of the resin coating may be controlled by the amount of the beads, and according to the present invention, the beads are present in an amount of from about 0.1 to about 10 parts by weight per 100 parts by weight of the solids content of the second resin coating.

According to another preferred embodiment of the present invention, a second resin coating containing beads is coated on the substrate, and then cured and shaped, such that concave-convex structures containing diffusion beads are formed on the second surface.

In general, if the haze of the optical element is too high, the overall brightness gain of the optical element can be affected. However, if the haze is too low, the light diffusion is insufficient. Therefore, in the case that the first surface of the substrate does not have any structure, the haze measured according to JIS K7136 is preferably not less than 3%, and more preferably is 10% to 70%.

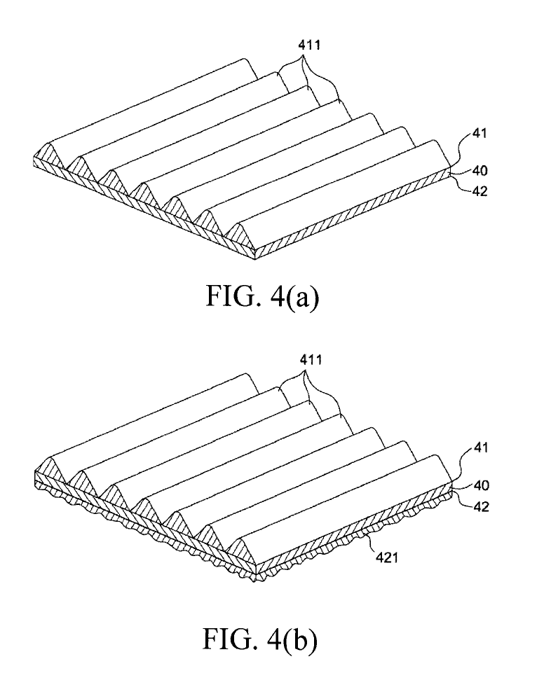

FIGS. 4 to 7 are schematic views of the embodiments of the optical element according to the present invention.

As shown in FIG. 4(a), the optical element of the present invention includes a substrate 40, a first surface 41 of the substrate 40 which includes a plurality of prism columnar structures 411 with rounded peaks, wherein the prism columnar structures are linear columnar structures and are parallel to each other, and a second surface 42 of the optical element which is a plane.

As shown in FIG. 4(b), the optical element of the present invention includes a substrate 40, a first surface 41 of the substrate 40 which includes a plurality of prism columnar structures 411 with rounded peaks, wherein the prism columnar structures are linear columnar structures and are parallel to each other, and a second surface 42 of the optical element which has concave-convex structures 421 without diffusion beads.

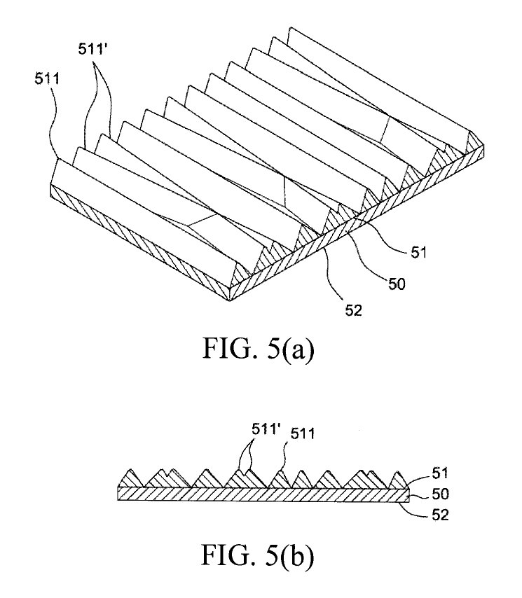

As shown in FIGS. 5(a) and 5(b), the optical element of the present invention includes a substrate 50, a first surface 51 of the substrate 50 which includes a plurality of prism columnar structures 511 with rounded peaks, among which at least two prism columnar structures 511′ are not parallel to each other, and a second surface 52 of the optical element which is a plane.

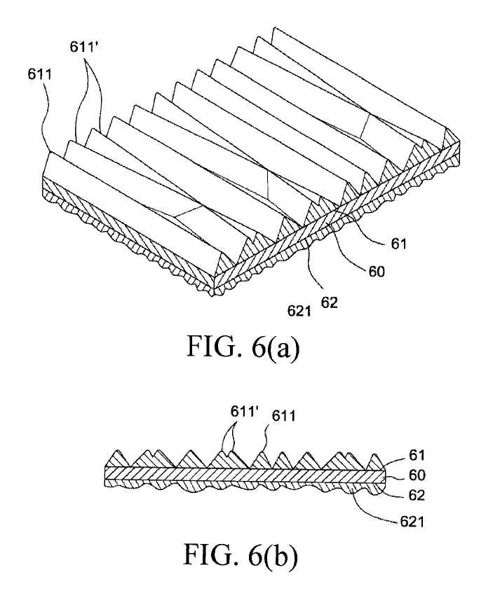

As shown in FIGS. 6(a) and 6(b), the optical element of the present invention includes a substrate 60, a first surface 61 of the substrate 60 which includes a plurality of prism columnar structures 611 with rounded peaks, among which at least two prism structures 611′ are not parallel to each other, and a second surface 62 of the optical element which has concave-convex structures 621 without diffusion beads.

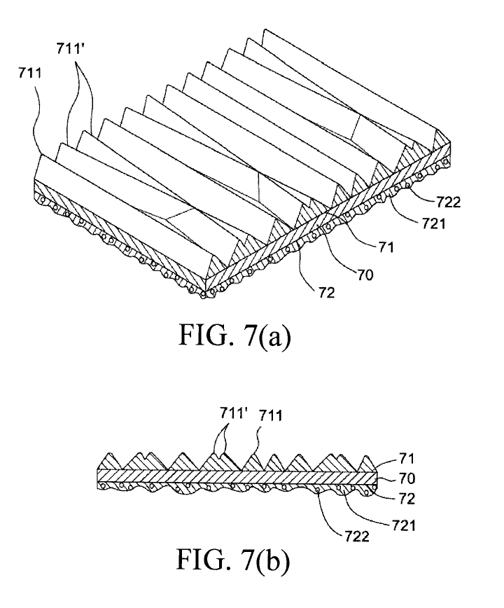

As shown in FIGS. 7(a) and 7(b), the optical element of the present invention includes a substrate 70, a first surface 71 of the substrate 70 which includes a plurality of prism columnar structures 711 with rounded peaks, among which at least two prism structures 711′ are not parallel to each other, and a second surface 72 of the optical element which has concave-convex structures 721 with diffusion beads 722.

The first resin coating and the second resin coating of the present invention may be the same or different, and each contain at least one resin selected from the group consisting of ultraviolet (UV) curable resin, thermosetting resin, thermoplastic resin and a mixture thereof, among which the ultraviolet curable resin is preferred.

The UV curable resins useful for the present invention are formed from an acrylate monomer having one- or multi-functional groups, of which the acrylates with multi-functional groups are preferred. Suitable acrylates include, for example, but are not limited to, (meth)acrylates such as 2-hydroxy-3-phenoxypropyl acrylate; a urethane acrylate such as an aliphatic urethane acrylate, an aliphatic urethane hexaacrylate, or an aromatic urethane hexaacrylate; polyester acrylates such as polyester diacrylates; epoxy acrylates such as bisphenol-A epoxy diacrylate, and novolac epoxy acrylate, or a mixture thereof, of which the urethane acrylate or epoxy acrylate or a mixture thereof is preferred.

The commercially available acrylates suitable for the present invention include those with the trade names SR454®, SR494®, SR9020®, SR9021® and SR9041®, produced by Sartomer Company; those with the trade names 6149-100®, 621-100®, 624-100®, and 6161-100® produced by Eternal Company; and those with the trade names Ebecryl 600®, Ebecryl 830®, Ebecryl 3605® and Ebecryl 6700®, produced by UCB Company.

The thermosetting resins suitable for the present invention typically have an average molecular weight in a range from 10⁴ to 2×10⁶, preferably from 2×10⁴ to 3×10⁵, and more preferably from 4×10⁴ to 10⁵. The thermosetting resins of the present invention can be selected from the group consisting of a carboxyl (—COON) and/or hydroxyl (—OH) group-containing polyester resins, epoxy resins, poly(meth)acrylate resins, polyamide resins, fluoro resins, polyimide resins, polyurethane resins, and alkyd resins, and a mixture thereof, of which the poly(meth)acrylate resins containing a carboxy (—COON) and/or hydroxyl (—OH) group are preferred.

The thermoplastic resins that can be used in the present invention are selected from the group consisting of polyester resins; polymethacrylate resins, such as polymethyl methacrylate (PMMA); and a mixture thereof.

The first resin coating and/or the second resin coating of the present invention can optionally contain any additives known to persons of ordinary skill in the art, which include, but are not limited to, a diluent, a photo initiator, a slip agent, a solvent, an anti-static agent, a leveling agent, a stabilizing agent, a fluorescent whitening agent, and a UV absorber.

To avoid an excessively high molecular weight and viscosity of the resin coatings that can deteriorate the processability of the coatings due to a poor leveling property when being applied, a dilent can be optionally added to the coatings to adjust the viscosity. Suitable diluents for the present invention include mono-functional or multi-functional acrylate monomers, which are, for example, selected from the group consisting of (meth)acrylates, 2-phenoxyl ethyl acrylate, 2-(2-ethoxyethoxy)ethyl acrylate; EOEOEA, cumyl phenoxyl ethyl acrylate, tripropylene glycol di(meth)acrylate, 1,4-butanediol di(meth)acrylate, 1,6-hexanediol di(meth)acrylate, polyethyleneglycol di(meth)acrylate, allylated cyclohexyl di(meth)acrylate, isocyanurate di(meth)acrylate, ethoxylated trimethylol propane tri(meth)acrylate, propoxylated glycerol tri(meth)acrylate, ethoxylated bisphenol-A dimethacrylate, trimethylol propane tri(meth)acrylate, tris(acryloxyethyl)isocyanurate, propoxylated neopentyl glycol diacrylate, ethoxylated trimethylolpropane triacrylate, propoxylated trimethyloipropane triacrylate, pentaerythritol triacrylate, dipentaerythritol hexaacrylate; DPHA, and a mixture thereof, among which 2-phenoxyl ethyl acrylate, pentaerythritol triacrylate, ethoxylated bisphenol-A dimethacrylate, 2-(2-ethoxyethoxy)ethyl acrylate, and dipentaerythritol hexaacrylate, and a mixture thereof are preferred.

Commercially available diluents that are useful for the present invention include those with the trade names EM2108®, EM210®, EM211®, EM212®, EM213®, EM215®, EM315®, EM3265®, EM235®, EM70®EM231® produced by Eternal company; and those with the trade names A-LEN10 and A-BPEFA produced by SHIN-NAKAMURA company.

According to the present invention, a diluent with an alkoxy group may be optionally added to the first resin coating or the second resin coating. The diluents with an alkoxy group can adjust the elastic modulus of the resin coating after curing such that the obtained structure has good flexibility and resilience, thereby increasing the scratch resistance of the optical element.

The photo initiator used in the present invention will generate free radicals after being irradiated, and initiate a polymerization through delivering the free radicals. Examples of the photo initiator include, but are not limited to, benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide (TPO), or a mixture thereof. Preferably, the photo initiator is benzophenone.

In order to increase the lubricity after curing, the first resin coating and/or the second resin coating of the present invention may optionally contain a slip agent. The slip agent applicable to the present invention is selected from the group consisting of amide resins, acrylate resins, naphthenates, silicone resins and aliphatic alcohol resins, among which the naphthenates and silicone resins are preferred. Commercially available slip agents include that manufactured by Tego Corporation, under the trade name Rad 2300.

In order to prevent the optical properties from being affected due to structural sag, an inorganic filler can be optionally added to the first resin coating and/or the second resin coating of the present invention. Moreover, the inorganic filler also has the effect of enhancing the brightness of LCD panels. The inorganic filler applicable in the present invention is well known to persons of ordinary skill in the art, and may be, for example, but is not limited to zinc oxide, silicon dioxide, strontium titanate, zirconia, alumina, calcium carbonate, titania, calcium sulfate, barium sulfate or a mixture thereof, among which zinc oxide, silicon dioxide, zirconia, and titania and a mixture thereof are preferred. The inorganic filler has a particle size in the range from about 10 nm to about 350 nm, and preferably in the range from about 50 nm to about 150 nm.

When the thermosetting resin or thermoplastic resin is used, a solvent may be optionally added. The solvent applicable in the present invention is well known to persons skilled in the art, and may be, for example, a benzene solvent, an ester solvent, or a ketone solvent or a mixture thereof. The benzene solvents include, for example, but are not limited to, benzene, o-xylene, m-xylene, p-xylene, trimethyl benzene, and styrene, and a mixture thereof. The ester solvents include, for example, but are not limited to, ethyl acetate, butyl acetate, diethyl carbonate, ethyl formate, methyl acetate, 2-ethoxyethyl acetate, ethoxypropyl acetate, and propylene glycol monomethyl ether ester, and a mixture thereof. The ketone solvents include, for example, but are not limited to, propanone, methyl ethyl ketone, and methyl isobutyl ketone, and a mixture thereof.

According to a preferred embodiment of the present invention, the first resin coating and/or the second resin coating of the present invention contains a UV curable resin, a diluent with an alkoxy group, and a photo initiator.

The optical element of the present invention has a high refractive index of at least 1.5, preferably about 1.52 to 1.65, and thus can provide a good optical gain. The coating is free of halogen, and does not cause environmental pollution. Moreover, the first surface and/or the second surface of the optical element manufactured in the present invention has resilient property, which can prevent the optical element from being scratched during transportation or operation, so that the protection effect can be achieved without adhering a protective film, and the process of adhering and removing the protective film can be avoided. The optical element of the present invention may be used in a light source device, for example, an advertising lamp box, a flat-panel display, or an LED illumination device, and may be particularly used in a direct lighting backlight module, so as to serve as a light-uniformizing optical element or scratch-resistant optical element. The optical element of the present invention has light uniformizing and converging effects, and has good resilience which can prevent the optical element from being scratched or scratching other adjacent elements.

The optical element of the present invention and preparation method thereof will be further described through the following examples.

### EXAMPLES

### Lamp Mura Test

### Working Example of Optical Measurement

In a direct lighting backlight module, several lamps were located below the backlight module to provide a light source for a display. The light source provided by the direct lighting backlight module was a linear light source, and if the light uniformizing effect of the optical element used is not good, bright and dark stripes may happen due to the arrangement of the lamps, which is referred to as a “Lamp Mura” phenomenon, and significantly affects the quality of display image.

In the prior art, no method can be used for quantifying Lamp Mura, and Lamp Mura can only be determined by naked eyes, but cannot be specifically evaluated. The present invention provides a method for quantifying light uniformity of a backlight module, in which an average brightness value can be obtained through particular calculation, and the elimination of Lamp Mura is evaluated according to the magnitude of the average brightness value.

The method of the present invention is as follows.

1. The backlight module is evenly divided into left, central, and right regions.

2. A longitudinal central axis of each region is defined, and brightness values of different test points on the axis are measured.

3. The brightness values obtained on the longitudinal central axis of each region are normalized in the following manner:

L: brightness values of the different test points on a certain longitudinal central axis;

Lₘᵢₙ: the minimum brightness value of the different test points on a certain longitudinal central axis;

L_{d}=L−Lₘᵢₙ;

L_{dmax}: maximum L_{d};

Lₙₒᵣ=L_{d}/L_{dmax}.

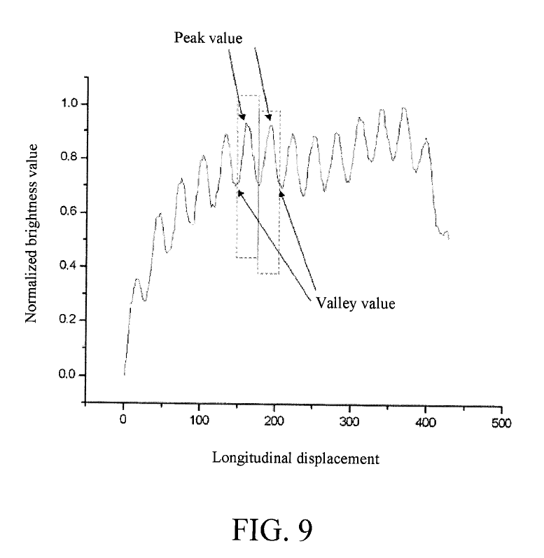

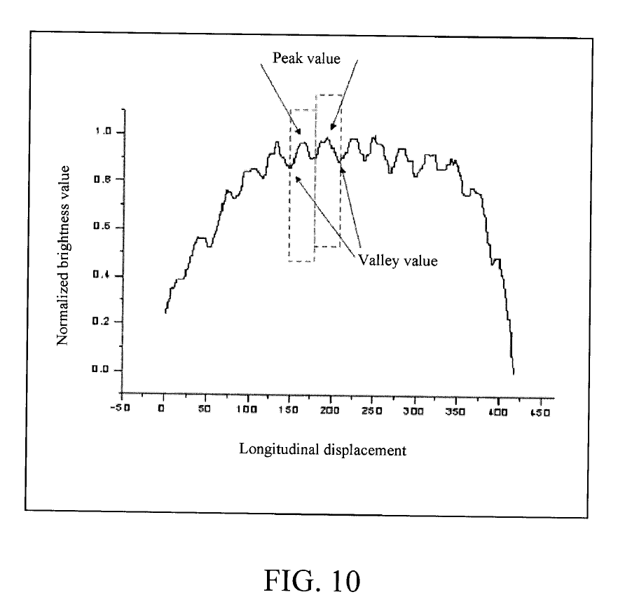

4. A drawing is plotted according to the normalized brightness value (Lₙₒᵣ) of each point on the longitudinal central axis of the central region with respect to the position of point, and a schematic brightness diagram like FIG. 9 or 10 (FIGS. 9 and 10 will be described in detail below) can be obtained, in which the normalized brightness values have a waveform distribution with respect to the positions of the points.

5. Highly different data at two end points of the central axis are excluded, and in each wave, a minimum Lₙₒᵣ is taken as a valley value, and a maximum Lₙₒᵣ is taken as a peak value, so as to obtain a ratio of the minimum Lₙₒᵣ to the maximum Lₙₒᵣ of each wave.

6. The ratios of the minimum Lₙₒᵣ to the maximum Lₙₒᵣ of all the waves obtained in Step 5 are summed and averaged, so as to obtain an average brightness value (S_{C}) for representing the average brightness value of the central region.

7. Steps 4 to 6 are repeated to obtain average brightness values (S_{L} and S_{R}) of the left and right regions, and then the average brightness values of the left, central, and right regions are summed and averaged (S=(S_{C}+S_{L}+S_{R})/3), so as to obtain an average brightness value (S) of the whole backlight module.

The closer the average brightness value (S) is to 1, the smaller the difference between the brightness peak and valley values is, and the less obvious the Lamp Mura phenomenon is. On the contrary, the smaller the average brightness value (S) is, the larger the difference between the brightness peak and valley values is, and the more obvious the Lamp Mura phenomenon is.

### Example 1

A commercially available resin coating A (Model 6510H®, available from Eternal Chemical Co., Ltd.) is coated on a polyethylene terephthalate (PET) substrate (Model U34®, manufactured by TORAY INDUSTRIES INC.) to form a coating, a plurality of prism columnar structures with rounded peaks is formed on the coating by embossing with a roller, and then the coating is cured by UV irradiation (350 mJ/cm²), so as to fabricate a microstructure layer. The fabricated microstructure layer has a thickness of 40 μm, and the prism columnar structures have a width of 50 μm, and the curvature radii (R) of the rounded peaks are 10 μm.

A resin coating A is coated on the other side (the second optical surface) of the substrate, opposite to the microstructure layer, to form a coating, and concave-convex patterns are formed on the coating by embossing with a roller, and at the same time, the coating is cured by UV irradiation (350 mJ/cm²). The fabricated coating has concave-convex structures and has a thickness of 10 μm.

The preparation methods of the following examples are the same as the above, except that variations are made to the structure of the microstructure layer.

### Example 2

An optical element is prepared by using the method of Example 1. The microstructure layer of the optical element includes a plurality of prism columnar structures with rounded peaks, and has a thickness of 40 μm. The prism columnar structures have a width of 60 μm, and the curvature radii (R) of the rounded peaks are 7 μm. The second optical surface of the optical element has concave-convex structures.

### Example 3

An optical element is prepared by using the method of Example 1. The microstructure layer of the optical element includes a plurality of prism columnar structures with rounded peaks, and has a thickness of 40 μm. The prism columnar structures have a width of 60 μm, and the curvature radii (R) of the rounded peaks are 5 μm. The second optical surface of the optical element has concave-convex structures.

### Example 4

An optical element is prepared by using the method of Example 1. The microstructure layer of the optical element includes a plurality of prism columnar structures with rounded peaks, and has a thickness of 40 μm. The prism columnar structures have a width of 50 μm, and the curvature radii (R) of the rounded peaks are 5 μm. The second optical surface of the optical element has concave-convex structures.

### Example 5

An optical element is prepared by using the method of Example 1. The microstructure layer of the optical element includes a plurality of prism columnar structures with rounded peaks, and has a thickness of 40 μm. The prism columnar structures have a width of 50 μm, and the curvature radii (R) of the rounded peaks are 5 μm. Moreover, the second optical surface of the optical element is not coated.

### Example 6

An optical element is prepared by using the method of Example 1. The microstructure layer of the optical element includes a plurality of prism columnar structures with rounded peaks, and has a thickness of 40 μm. The prism columnar structures have a width of 50 μm, and the curvature radii (R) of the rounded peaks are 3 μm. The second optical surface of the optical element has concave-convex structures.

### Example 7

An optical element is prepared by using the method of Example 1. The microstructure layer of the optical element includes a plurality of prism columnar structures with rounded peaks, and has a thickness of 40 μm. The prism columnar structures have a width of 50 μm, and the curvature radii (R) of the rounded peaks are 2 μm. The second optical surface of the optical element has concave-convex structures.

### Example 8

An optical element is prepared by using the method of Example 1. The microstructure layer of the optical element includes a plurality of prism columnar structures with rounded peaks, and has a thickness of 40 μm. The prism columnar structures have a width of 60 μm, and the curvature radii (R) of the rounded peaks are 5 μm. The second optical surface of the optical element has concave-convex structures containing beads (manufactured by Sekisui Plastics Co., Ltd., Model SSX-102).

### Example 9

An optical element is prepared by using the method of Example 1. The microstructure layer of the optical element includes a plurality of prism columnar structures with sharp apexes (that is, R is 0 μm), and has a thickness of 40 μm. The prism columnar structures have a width of 50 μm. The second optical surface of the optical element has concave-convex structures.

### Example 10

Commercially available optical element: Micro Lens (PTR-863, SHINWHA Intertek Corporation).

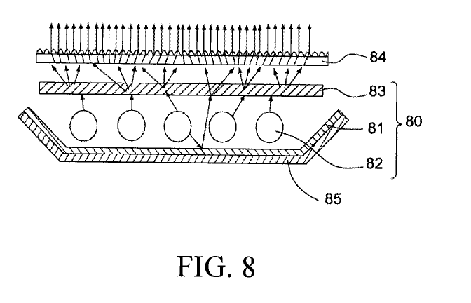

As shown in FIG. 8, a lamp box 80 for use in a 42″ backlight module is provided. The lamp box has a thickness of 24 mm. The lowest layer of the lamp box is a supporting steel plate 85, a reflector 81 is adhered on the steel plate, 16 CCFL lamps 82 (the figure only shows lamp positions, but does not show all the lamps) are evenly disposed and fixed above the reflector, a supporting diffuser plate 83 is placed on a layer above the lamps, and then the optical element 84 of the above Examples is placed above the diffuser plate, so as to achieve a light uniformizing effect. Afterward, brightness measurement is carried out using a brightness meter Topcon UA-1000, and the brightness value of the central point of the optical element of Example 1 is defined as 100%. Then, measurement and calculation are carried out according to the method disclosed above to calculate the average brightness value S of the entire module, and the results are as shown in FIGS. 9 and 10 and Table 1.

FIG. 9 is a diagram of normalization of brightness values of the longitudinal central axis of the central region of the backlight module when none of the optical elements of the Examples exists (that is, when the backlight module only has the supporting steel plate, the reflector, the lamps and the diffuser plate).

FIG. 10 is a diagram of normalization of brightness values of the longitudinal central axis of the central region of the backlight module when the optical element of Example 1 is used.

It can be seen through comparison of FIG. 9 and FIG. 10 that, the placement of the optical element of the present invention can reduce the difference between the peak value and the valley value, thereby significantly improving the effect on eliminating Lamp Mura.

TABLE 1

| | Prism | | Second Optical | Central | |
|---|---|---|---|---|---|
| Example | Width | R | Surface | Brightness | S Value |
| 1 | 50 | 10 | concave-convex | 100% | 0.91502 |
| 2 | 60 | 7 | concave-convex | 104.7% | 0.91389 |
| 3 | 60 | 5 | concave-convex | 104.9% | 0.91279 |
| 4 | 50 | 5 | concave-convex | 104.0% | 0.91256 |
| 5 | 50 | 5 | planar | 107.6% | 0.89358 |
| 6 | 50 | 3 | concave-convex | 105.6% | 0.90662 |
| 7 | 50 | 2 | concave-convex | 107.3% | 0.89406 |
| 8 | 60 | 5 | concave-convex | 103.5% | 0.91560 |
| | | | and including | | |
| | | | beads | | |
| 9 | 50 | 0 | concave-convex | 112.0% | 0.88725 |
| 10 | — | semi- | concave-convex | 99.4% | 0.91457 |
| | | spherical | | | |

It can be seen through comparison of the results of Examples 2 and 3 or comparison of the results of Examples 1, 4, 6, 7 and 9 that, increasing the curvature radii of the rounded peaks of the microstructure layer improves the effect on eliminating Lamp Mura, but reduces the brightness. In addition, it can be seen through comparison of the results of Examples 3 and 4 that, increasing the prism width does not help much in eliminating Lamp Mura, but can enhance the brightness. In addition, It can be seen through comparison of the results of Examples 3 and 8 that, the diffusion beads in the second optical surface also help in eliminating Lamp Mura.

### <Scratch & Abrasion Tests>

In general, the larger the curvature radii (R) of the rounded peaks are, the better the scratch resistance is, but the poorer the brightness will be. In addition to the prism columnar structures with rounded peaks, the present invention further uses different resin coating formulas, so as to make the microstructures resilient and increase the scratch resistance thereof. Therefore, good scratch resistance can be achieved without using excessively large curvature radii, thereby reducing the adverse effect of excessively large curvature radii on the brightness.

### Preparation of Resin Coatings B, C and D

Resin coatings B, C and D are prepared according to the method described below, and the composition of the formulas is as shown in Table 2.

Firstly, the components are mixed at a weight ratio listed in Table 2, and stirred at 50° C. and at a speed rate of 1,000 rpm, so as to form the resin coatings B, C and D.

TABLE 2

| | Resin | | |
|---|---|---|---|
| | Coating | | |
| Composition | B | C | D |
| a | 55 | 0 | 0 |
| b | 0 | 50 | 0 |
| c | 10 | 30 | 35 |
| d | 30 | 0 | 0 |
| e | 0 | 15 | 10 |
| f | 5 | 5 | 5 |
| g | 0 | 0 | 50 |

a: Ultraviolet curable resin (manufactured by Eternal Chemical Co., Ltd., 6149-100 ®)
b: Ultraviolet curable resin (manufactured by Eternal Chemical Co., Ltd., 621-100 ®)
c: Diluent (manufactured by Eternal Chemical Co., Ltd., EM210 ®)
d: Diluent (manufactured by Eternal Chemical Co., Ltd., EM3265 ®)
e: Diluent (manufactured by Eternal Chemical Co., Ltd., EM235 ®)
f: Photo initiator (manufactured by Ciba Corporation, I184)
g: Ultraviolet curable resin (manufactured by Eternal Chemical Co., Ltd., 624-100 ®)

Preparatory Work:

The resin coating D is coated on a PET substrate (Model U34®, manufactured by TORAY INDUSTRIES INC.) to form a coating layer, concave-convex structures are formed on the coating layer by embossing with a sand blasting roller, and then, the coating is cured by UV irradiation (350 mJ/cm²), so as to fabricate a second optical surface having concave-convex structures.

### Example 11

The resin coating B is coated on the first optical surface of the substrate to form a coating layer, a plurality of prism columnar structures with rounded peaks is formed on the coating layer by embossing with a roller, and then the coating is cured by UV irradiation (350 mJ/cm²), so as to fabricate a microstructure layer. The fabricated microstructure layer has a thickness of 40 μm, the curvature radii (R) of the peaks of the prism columnar structures are 10 μm, and the prism width is 60 μm.

### Examples 12 to 15

Microstructure layers having prism columnar structures with peak curvature radii (R) of 5, 3, 2 and 0 μm are respectively prepared with the resin coating B by using the method of Example 11 (the thickness of the microstructure layer is maintained at 40 μm, and the prism width is maintained at 60 μm).

### Example 16

A microstructure layer having prism columnar structures with peak curvature radii (R) of 5 μm is prepared with the resin coating C by using the method of Example 11 (the thickness of the microstructure layer is maintained at 40 μm, and the prism width is maintained at 60 μm).

### Example 17

BEF III commercially available from 3M.

### Test Methods:

Measurement of the curvature radii (R) of the peaks: the curvature radii of the peaks of the prism columnar structures are measured using MM400-Lu metallographic microscope RLM615 instrument from Nikon Corporation, and the results are recorded in Table 3.

Pencil Hardness Test: the pencil hardness of the microstructure layer is tested using a Pencil Hardness Tester [Elcometer 3086, SCRATCH BOY] with a Mitsubishi pencil according to JIS K-5400, and the results are recorded in Table 3.

Test of the refractive index of the resin coating: the refractive index of the resin coating is measured using AUTOMATIC REFRACTOMETER GPR11-37® instrument from Index Instruments, and the results are recorded in Table 3.

Glass transition temperature (Tg) test: the glass transition temperature of the microstructure layer is measured using DSC7 instrument from PerkinElmer Instruments, and the results are recorded in Table 3.

Scratch test: a linear abrasion tester [TABER 5750] is used, a film to be tested (20 mm long×20 mm wide) is adhered on a 350 g weight platform (20 mm long×20 mm wide) with the microstructure layer thereof facing upward, and a scratch test is carried out for 10 cycles at a test stroke of 0.5 inch and a rate of 10 cycle/min by using the second surface of another film of the same type. It is determined through observation whether the microstructure layer and the second surface are scratched, and if neither of the two is scratched, the test is passed. The results of the test are as shown in Table 3 below.

Abrasion test: a film to be tested (100 mm long×100 mm wide) is provided, and the abrasion resistance of the microstructure layer is tested using ASTM D4060 (CS-10 wheel, 1,000 g, 1,000 cycles), and if the weight loss is less than 100 mg, the test is passed.

TABLE 3

| | | | Refractive | | | | |
|---|---|---|---|---|---|---|---|
| | | | Index of | | | | |
| | | Resin | Microstructure | Pencil | | Scratch | Abrasion |
| Example | R | coating | Layer | Hardness | Tg | Test | Test |
| 11 | 10 μm | B | 1.507 | HB | 20° C. | ◯ | ◯ |
| 12 | 5 μm | B | 1.507 | HB | 20° C. | ◯ | ◯ |
| 13 | 3 μm | B | 1.507 | HB | 20° C. | ◯ | ◯ |
| 14 | 2 μm | B | 1.507 | B | 20° C. | X | X |
| 15 | 0 μm | B | 1.507 | B | 20° C. | X | X |
| 16 | 5 μm | C | 1.548 | 6B | 42° C. | X | X |
| 17 | 0 μm | — | — | B | 78° C. | X | X |

O: Passing the test
X: Failing to pass the test

It can be seen from the results of Examples 11 to 15 that, when the microstructure layer is formed using the resin coating B, if R is larger than 3 μm, the weight loss of the abrasion test is less than 100 mg, the HB Pencil Hardness Test can be passed, and the microstructures will not be scratched.

In Example 16, the microstructure layer is formed using the resin coating C. In this case, even if the R value is up to 5 μm, the glass transition temperature is higher than 40° C., the HB Pencil Hardness Test cannot be passed, and the microstructures will be scratched.

It can be seen from the results of Example 17 that, the glass transition temperature of the microstructure layer of the commercially available BEF III is higher than 40° C., the HB Pencil Hardness Test cannot be passed, and the microstructures will be scratched.

The larger the R value is, the better the scratch resistance is. However, if the R value is too large, the brightness of the optical element is sacrificed. Therefore, it is one of important inventive features to reduce the R value while enabling the microstructure layer to be scratch resistant and flexible. In Examples 12 and 16, the curvature radii of the peaks of the prism columnar structures are 5 μm. In Example 12, the microstructure layer is prepared using the resin coating B, and the fabricated microstructure layer is flexible, has a glass transition temperature smaller than 40° C., and can pass the scratch test of the present invention. On the contrary, in Example 16, the microstructure layer is prepared using the resin coating C, and the fabricated microstructure layer is rigid, has a glass transition temperature of up to 42° C., and cannot pass the scratch test of the present invention.

What is claimed is:

1. An optical element, comprising
(a) a substrate;
(b) a first surface on one side of the substrate wherein said first surface comprises a plurality of prism columnar structures with rounded peaks and the rounded peaks have curvature radii in the range from 3 μm to 20 μm, and
(c) a second surface on the other side of the substrate wherein the second surface is a plane surface or has concave-convex structures.

2. The optical element as claimed in claim 1, wherein at least two of the prism columnar structures are non-parallel to each other.

3. The optical element as claimed in claim 2, wherein said non-parallel prism columnar structures are intersecting or non-intersecting.

4. The optical element as claimed in claim 1, wherein the second surface has concave-convex structures.

5. The optical element as claimed in claim 4, wherein the second surface has concave-convex structures that do not contain diffusion beads.

6. The optical element as claimed in claim 4, wherein the second surface has concave-convex structures that contain diffusion beads.

7. An optical element, comprising:
(a) a substrate;
(b) a first surface on one side of the substrate wherein said first surface comprises a plurality of prism columnar structures with rounded peaks and the rounded peaks have curvature radii in the range from 3 μm to 20 μm, and
(c) a second surface on the other side of the substrate wherein the second surface has concave-convex structures, wherein the prism columnar structures have a glass transition temperature less than 40° C.

8. The optical element as claimed in claim 7, wherein the organic particles are uniformly distributed in the resin coating in a single layer.

9. The optical film as claimed in claim 1, wherein in the case that the first surface of the substrate does not have any structure, the optical film has a haze not less than 3%, as measured according to JIS K7136.

10. An optical element, comprising:
(a) a substrate;
(b) a first surface on one side of the substrate wherein said first surface comprises a plurality of prism columnar structures with rounded peaks and the rounded peaks have curvature radii in the range from 3 μm to 20 μm, and
(c) a second surface on the other side of the substrate wherein the second surface is a plane surface or has concave-convex structures,
wherein the prism columnar structures have an abrasion loss less than 100 mg, as tested according to ASTM D4060 (CS-10 wheel, 1,000 g, 1,000 cycles).

11. The optical element as claimed in claim 10, wherein the prism columnar structures can pass an HB Pencil Hardness Test, as tested according to JIS K-5400.

12. A direct lighting backlight module, comprising an optical element as claimed in any of claims 1 to 11.
